(19) United States
(12) Patent Application Publication
(10) Pub. No.: US 2016/0044896 A1
(43) Pub. Date: Feb. 18, 2016

(54) Claw Trimming Assembly

(71) Applicant: Jessica Bo, Canton, MI (US)

(72) Inventor: Jessica Bo, Canton, MI (US)

(21) Appl. No.: 14/458,348

(22) Filed: Aug. 13, 2014

(51) Int. Cl. A01K 17/00; F21V 33/00; F21V 21/14; A01K 13/00

(52) U.S. Cl. CPC A01K 17/00; A01K 13/00; F21V 33/0084; F21V 21/145; F21Y 2101/02

(57) ABSTRACT

A claw trimming assembly includes a pair of pliers structured to have a pair of cutting members urged toward each other when the pair of pliers are squeezed. The pair of pliers may trim a claw of an animal. A light emitter is movably coupled to the pair of pliers. The light emitter emits light onto the claw of the animal so the claw may be trimmed without injuring the animal. A sharpener removably coupled to the pair of pliers. The sharpener is structured to engage each of the pair of cutting members of the pliers. The sharpener may sharpen the pair of cutting members.

### BACKGROUND OF THE DISCLOSURE

### Field of the Disclosure

The disclosure relates to trimming devices and more particularly pertains to a new trimming device for trimming a claw of an animal.

### SUMMARY OF THE DISCLOSURE

An embodiment of the disclosure meets the needs presented above by generally comprising a pair of pliers structured to have a pair of cutting members urged toward each other when the pair of pliers are squeezed. The pair of pliers may trim a claw of an animal. A light emitter is movably coupled to the pair of pliers. The light emitter emits light onto the claw of the animal so the claw may be trimmed without injuring the animal. A sharpener removably coupled to the pair of pliers. The sharpener is structured to engage each of the pair of cutting members of the pliers. The sharpener may sharpen the pair of cutting members.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left side of a claw trimming assembly according to an embodiment of the disclosure.

FIG. 2 is a right side of an embodiment of the disclosure.

FIG. 3 is a top view of an embodiment of the disclosure.

FIG. 4 is a front view of an embodiment of the disclosure.

FIG. 5 is a perspective view of a sharpener of an embodiment of the disclosure.

### DESCRIPTION OF THE PREFERRED EMBODIMENT

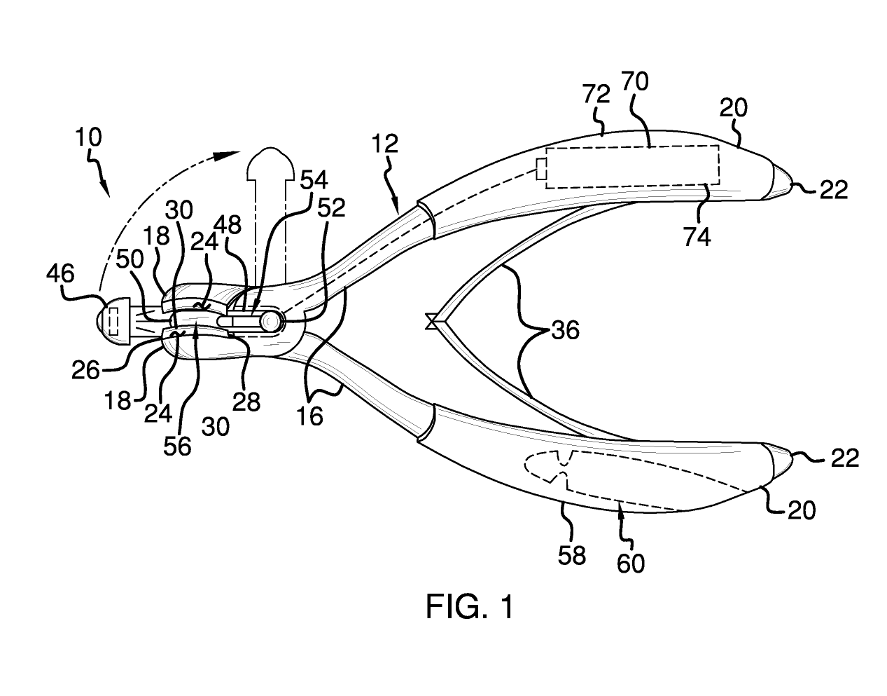

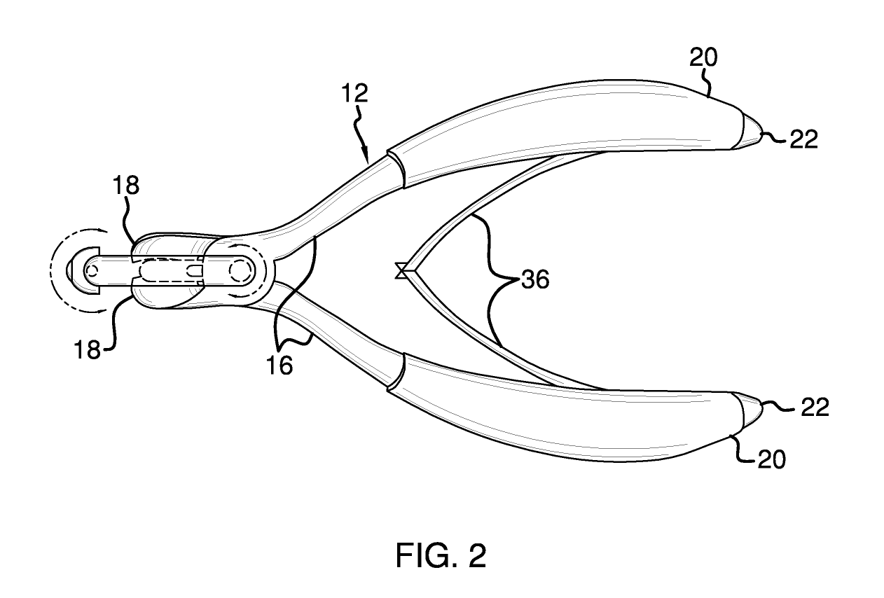

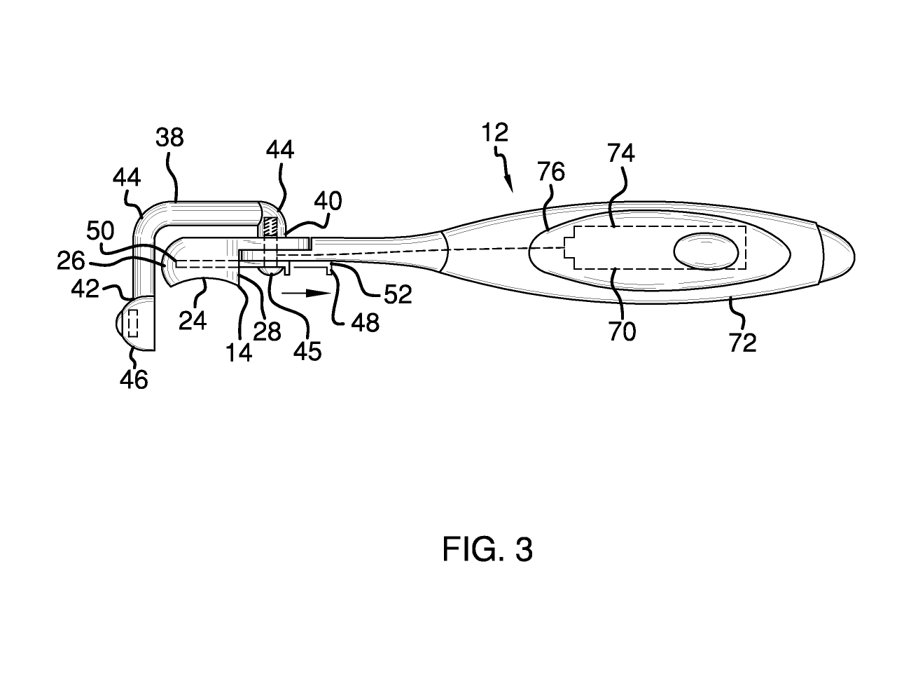

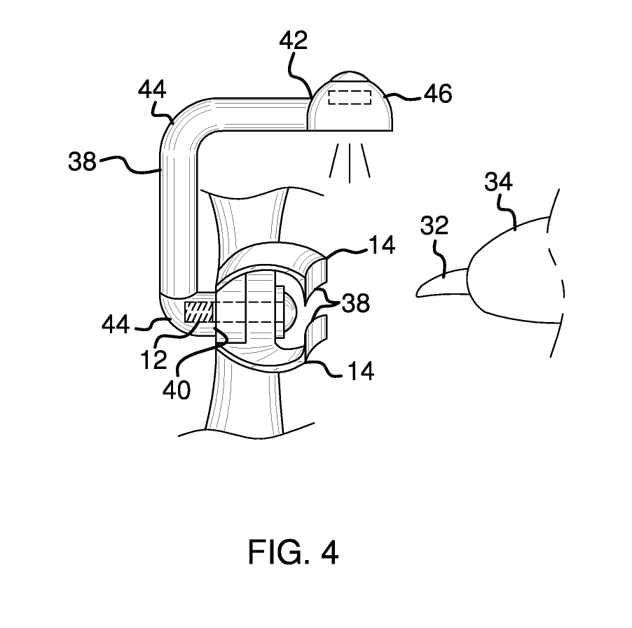

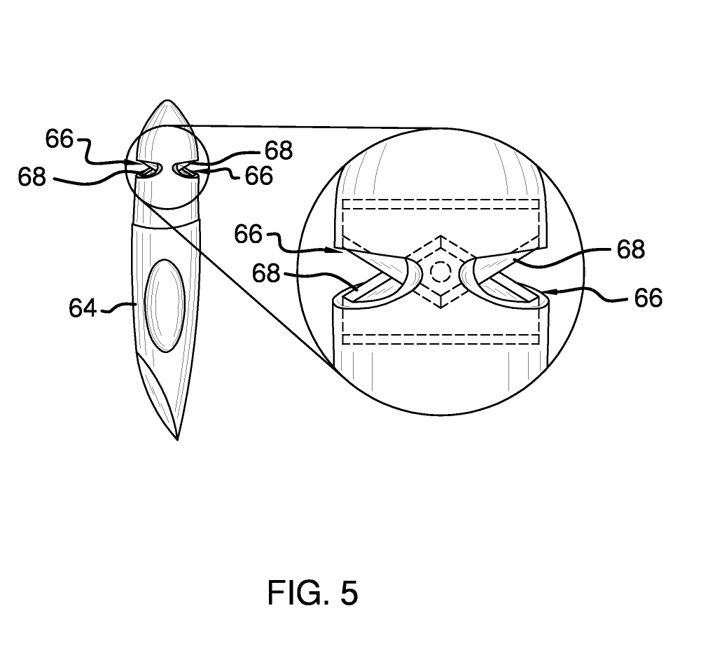

With reference now to the drawings, and in particular to FIGS. 1 through 5 thereof, a new trimming device embodying the principles and concepts of an embodiment of the disclosure and generally designated by the reference numeral 10 will be described.

As best illustrated in FIGS. 1 through 5, the claw trimming assembly 10 generally comprises a pair of pliers 12 structured to have a pair of cutting members 14. The pair of cutting members 14 each extends laterally away from an associated one of a pair of arms 16 of the pliers 12. Each of the cutting members 14 is positioned adjacent to a cutting end 18 of each of the arms 16 of the pliers 12. A pair of grips 20 is coupled to each of the arms 16 of the pliers 12. The pair of grips 20 extends upwardly from a gripping end 22 of each of the arms 16 of the pliers 12.

A forward surface 24 of the cutting members 14 curves inwardly between each of a front end 26 and a back end 28 of the cutting members 14. The forward surface 24 of the cutting members 14 has a concave shape. A bottom edge 30 of each of the cutting members 14 is sharpened. The bottom edge 30 of each of the cutting members 14 coextensively abuts one another when the arms 16 of the pliers 12 are squeezed. The bottom edge 30 of each of the cutting members 14 may cut a claw 32 of an animal 34.

A pair of rails 36 is coupled to and extends inwardly from each of the pair of arms 16 of the pliers 12. The pair of rails 36 are slidably coupled together. Additionally, the pair of rails 36 defines a maximum distance the pliers 12 may be opened.

A light mount 38 is provided. The light mount 38 has a coupled end 40 and a free end 42. The light mount 38 has a pair of bends 44 positioned thereon so the light mount 38 has a U-shape. The coupled end 40 of the light mount 38 is rotatably coupled to a central pin 45 in the pair of pliers 12. The free end 42 of the light mount 38 is positionable proximate the pair of cutting members 18. Additionally, the light mount 38 is movable so the free end 42 of the light mount 38 is positionable at a selected angle with respect to the cutting members 18.

A light emitter 46 is coupled to the free end 42 of the light mount 38. The light emitter 46 is positionable at a selected angle with respect to the pair of cutting members 18. The light emitter 46 emits light onto the claw 32 of the animal 34 so the claw 32 may be trimmed without injuring the animal 34. The light emitter 46 may be a LED of any conventional design.

A stop 48 is provided. The stop 48 has a primary end 50 and a secondary end 52. The stop 48 is elongated. The stop 48 has a slot 54 extending therethrough. The slot 54 extends between the secondary end 52 of the stop 48 and a middle 56 of the stop 48.

The central pin 45 of the pliers 12 extends through the slot 54 in the stop 48. The stop 48 is slidably coupled to the pliers 12. The primary end 50 of the stop 48 is positionable at a selected point along the length of the bottom edge 30 of the cutting members 18. The claw 32 of the animal 34 abuts the primary end 50 of the stop 48. The stop 48 determines an amount of the claw 32 that is trimmed.

A first one 58 of the pair of arms 16 of the pliers 12 has a sharpener well 60 extending inwardly therein. The sharpener well 60 is positioned proximate the gripping end 22 of the first arm 58 of the pliers 12. A sharpener 64 is provided. The sharpener 64 has a pair of openings 66 to expose a pair of sets of blades 68.

The sharpener 64 is structured to engage each of the pair of cutting members 14 of the pliers 12. The sharpener 64 is drawn across the bottom edge 30 of the cutting members 14 so the sets of blades 68 sharpens an associated one of the cutting members 14. The sharpener 64 is positionable within the sharpener well 60 so the sharpener 64 may be stored within the sharpener well 60. The sharpener 64 may be a carbide blade sharpener of any conventional design.

A power supply 70 is coupled to a second one 72 of the pair of arms 16 of the pliers 12. The power supply 70 is positioned within an interior of the second arm 72 of the pliers 12. The power supply 70 is electrically coupled to the light emitter 46. The power supply 70 comprises at least one battery 74. A battery cover 76 is removably coupled to the second arm 72 of the pliers 12. The battery 74 is positioned beneath the battery cover 76.

In use, the stop 48 is positioned at the selected position. The animal's 34 claw 32 is positioned between the pair of cutting members 14 so the animal's 34 claw 32 abuts the stop 48. The light emitter 46 is positioned to illuminate the animal's 34 claw 32. The gripping end 22 of the arms 16 of the pliers 12 are squeezed until the cutting members 18 cuts the animal's 34 claw 32. The stop 48 and the light emitter 46 prevents the animal's 34 claw 32 from being trimmed too short.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A claw trimming assembly comprising:
a pair of pliers structured to have a pair of cutting members urged toward each other when said pair of pliers are squeezed such that said pair of pliers are configured to trim a claw of an animal;
a light emitter movably coupled to said pair of pliers, said light emitter emitting light onto the claw of the animal such that the claw may be trimmed without injuring the animal; and
a sharpener removably coupled to said pair of pliers, said sharpener being structured to engage each of said pair of cutting members of said pliers such that said sharpener is configured to sharpen said pair of cutting members.

2. The claw trimming assembly according to claim 1, further comprising said pair of cutting members each extending laterally away from an associated one of a pair of arms of said pliers, each of said cutting members being positioned adjacent to a cutting end of each of said arms of said pliers.

3. The claw trimming assembly according to claim 2, further comprising a forward surface of said cutting members curving inwardly between each of a front end and a back end of said cutting members such that said forward surface of said cutting members has a concave shape.

4. The claw trimming assembly according to claim 3, further comprising a bottom edge of each of said cutting members being sharpened, said bottom edge of each of said cutting members coextensively abutting one another when said pliers are squeezed such that said bottom edge of each of said cutting members cuts the claw of the animal.

5. The claw trimming assembly according to claim 1, further comprising a light mount having a coupled end and a free end, said light mount having a pair of bends positioned thereon such that said light mount has a U-shape.

6. The claw trimming assembly according to claim 5, further comprising said coupled end of said light mount being rotatably coupled to a central pin in said pair of pliers such that said free end of said light mount is positionable proximate said pair of cutting members.

7. The claw trimming assembly according to claim 6, further comprising said light emitter being coupled to said free end of said light mount such that said light emitter is positionable at a selected angle with respect to said pair of cutting members.

8. The claw trimming assembly according to claim 1, further comprising a first one of a pair of arms of said pliers having a sharpener well extending inwardly therein, said sharpener well being positioned proximate a gripping end of said first arm of said pliers.

9. The claw trimming assembly according to claim 8, further comprising said sharpener being positionable within said sharpener well such that said sharpener is stored within said sharpener well.

10. The claw trimming assembly according to claim 1, further comprising a power supply coupled to a second one of a pair of arms of said pliers, said power supply being positioned within an interior of said second arm of said pliers.

11. The claw trimming assembly according to claim 10, further comprising said power supply being electrically coupled to said light emitter.

12. The claw trimming assembly according to claim 11, further comprising said power supply comprising at least one battery.

13. A claw trimming assembly comprising:
a pair of pliers structured to have a pair of cutting members, said pair of cutting members each extending laterally away from an associated one of a pair of arms of said pliers, each of said cutting members being positioned adjacent to a cutting end of each of said arms of said pliers;
a forward surface of said cutting members curving inwardly between each of a front end and a back end of said cutting members such that said forward surface of said cutting members has a concave shape;
a bottom edge of each of said cutting members being sharpened, said bottom edge of each of said cutting members coextensively abutting one another when said arms of said pliers are squeezed such that said bottom edge of each of said cutting members is configured to cut a claw of an animal;
a first one of said pair of arms of said pliers having a sharpener well extending inwardly therein, said sharpener well being positioned proximate a gripping end of said first arm of said pliers;
a light mount having a coupled end and a free end, said light mount having a pair of bends positioned thereon such that said light mount has a U-shape, said coupled end of said light mount being rotatably coupled to a central pin in said pair of pliers such that said free end of said light mount is positionable proximate said pair of cutting members;
a light emitter coupled to said free end of said light mount such that said light emitter is positionable at a selected angle with respect to said pair of cutting members, said light emitter emitting light onto the claw of the animal such that the claw may be trimmed without injuring the animal;
a sharpener being structured to engage each of said pair of cutting members of said pliers such that said sharpener is configured to sharpen said pair of cutting members, said sharpener being positionable within said sharpener well such that said sharpener is stored within said sharpener well; and
a power supply coupled to a second one of said pair of arms of said pliers, said power supply being positioned within an interior of said second arm of said pliers, said power supply being electrically coupled to said light emitter, said power supply comprising at least one battery.
